(19) United States
(12) Patent Application Publication
(10) Pub. No.: US 2026/0032620 A1
(43) Pub. Date: Jan. 29, 2026

(54) ENHANCED PASSIVE TRIGGER-BASED RANGING WITH RESPONDING STATION (RSTA) AND INITIATING STATION (ISTA) SELECTION

(71) Applicant: QUALCOMM Incorporated, San Diego, CA (US)

(72) Inventors: Akansh JAIN, Chennai (IN); G SRIRAM, Karaikudi (IN); Xiaoxin ZHANG, Sunnyvale, CA (US)

(21) Appl. No.: 18/781,554

(22) Filed: Jul. 23, 2024

(51) Int. Cl. H04W 64/00; H04B 17/309; H04B 17/318

(52) U.S. Cl. CPC H04W 64/00; H04B 17/318; H04B 17/346

(57) ABSTRACT

In some implementations, a passive station (PSTA) may determine one or more responding station (RSTA)-initiating station (ISTA) pairs from a plurality of RSTAs and a plurality of ISTAs, based on one or more measurements of one or more radio frequency (RF) signals received from stations of the plurality of RSTAs and ISTAs. In addition, the PSTA may obtain ranging measurements determined based on packets transmitted between the one or more RSTA-ISTA pairs. The PSTA may determine a location estimate of the PSTA based on the ranging measurements.

### TECHNICAL FIELD

The present disclosure relates generally to the field of radio frequency (RF)-based ranging in a wireless network and more specifically, relates to a method of trigger-based passive ranging based on responding station (RSTA) – initiating station (ISTA) pairs selections.

### BACKGROUND

In modern wireless communication systems, accurate location estimation plays an important role in a wide range of applications, including indoor navigation, asset tracking, and location-based services. The IEEE 802.11az and 802.11bk standards introduce significant enhancements to support high-accuracy positioning using existing Wi-Fi infrastructure. One of the key features of these standards is the Passive Location Ranging mode, which facilitates precise location estimation without requiring active transmission from the device being located.

### BRIEF SUMMARY

An example method for passive ranging performed by a passive station (PSTA), according to this disclosure, comprises determining one or more responding station (RSTA) - initiating station (ISTA) pairs from a plurality of RSTAs and a plurality of ISTAs, based on one or more measurements of one or more radio frequency (RF) signals received from stations of the plurality of RSTAs and ISTAs. The one or more measurements comprise: Received Signal Strength Indicator (RSSI), Angle of Arrival (AoA), Signal-to-Noise Ratio (SNR), Differential Time of Arrival (DToA), or any combination thereof. The method further comprises obtaining ranging measurements determined based on packets transmitted between the one or more RSTA – ISTA pairs; and determining a location estimate of the PSTA based on the ranging measurements.

An example passive station (PSTA), according to this disclosure, comprises: at least one transceiver; at least one memory; and at least one processor communicatively coupled with the at least one transceiver and at least one memory, the at least one processor configured to: determine one or more responding station (RSTA) – initiating station (ISTA) pairs from a plurality of RSTAs and a plurality of ISTAs, based on one or more measurements of one or more radio frequency (RF) signals received from stations of the plurality of RSTAs and ISTAs. The one or more measurements comprise: Received Signal Strength Indicator (RSSI) Angle of Arrival (AoA) Signal-to-Noise Ratio (SNR) Differential Time of Arrival (DToA), or any combination thereof. The at least one processor is further configured to obtain ranging measurements determined based on packets transmitted between the one or more RSTA-ISTA pairs, and determine a location estimate of the PSTA based on the ranging measurements.

An example device for passive ranging, according to this disclosure, comprises means for determining one or more responding station (RSTA) - initiating station (ISTA) pairs from a plurality of RSTAs and a plurality of ISTAs, based on one or more measurements of one or more radio frequency (RF) signals received from stations of the plurality of RSTAs and ISTAs. The one or more measurements comprise: Received Signal Strength Indicator (RSSI), Angle of Arrival (AoA), Signal-to-Noise Ratio (SNR), Differential Time of Arrival (DToA), or any combination thereof. The example device further comprises means for obtaining ranging measurements determined based on packets transmitted between the one or more RSTA – ISTA pairs, and means for determining a location estimate of a passive station (PSTA) based on the ranging measurements.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a communication/positioning/ranging system, according to an embodiment.

FIG. 2 is diagram of a fifth-generation new radio (5G NR) network, according to an embodiment.

FIG. 3 illustrates an example environment of how passive trigger-based ranging for a passive station (PSTA) may be performed.

FIG. 4 is a diagram showing an example of a radio frame sequence with passive trigger-based ranging between RSTA(s) and ISTAs.

FIG. 5 is a timing diagram showing an example passive trigger-based ranging measurement exchange for passive ranging a PSTA.

FIG. 6 is a flow chart showing an example improved passive trigger-based ranging for a PSTA, according to some embodiments.

FIG. 7 is a diagram showing an example environment of how RSTA may be selected for passive trigger-based ranging of a PSTA, according to some embodiments.

FIG. 8 is a diagram showing an example environment of how ISTA may be selected for passive trigger-based ranging, according to some embodiments.

FIG. 9 is a flow diagram of a method of passive ranging performed by a PSTA, according to some embodiments.

FIG. 10 is a block diagram of an embodiment of a PSTA, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the terms “RF sensing,” “passive RF sensing,” and variants refer to a process by which one or more objects are detected using RF signals transmitted by a transmitting device (transmitter) and, after reflecting from the one or more objects, received by a receiving device (receiver). In a monostatic configuration, the transmitting and receiving device are the same device. In bi- or multi-static configuration, one or more receiving devices are separate from one or more transmitting devices. As described hereafter in more detail, a receiving device can make measurements of these reflected RF signals to determine one or more characteristics of the one or more objects, such as location, angle, direction, orientation, Doppler, velocity, etc. According to some embodiments, RF sensing may be “passive” in that no RF signals need to be transmitted by the receiving device or one or more objects for the one or more objects to be detected.

Additionally, unless otherwise specified, references to “sensing signals,” “RF sensing signals,” “reference signals,” “sensing reference signals,” “reference signals for sensing,” and the like may be used to refer to signals used for sensing for a user equipment (UE). As described in more detail herein, such signals may comprise any of a variety of signal types but may not necessarily be limited to a Positioning Reference Signal (PRS) as defined in relevant wireless standards.

Techniques provided herein can apply generally to “mmWave” technologies, which typically operate at 57–71 GHz, but may include frequencies ranging from 30–300 GHz. This includes, for example, frequencies utilized by the 802.11ad Wi-Fi standard (operating at 60 GHz). That said, some embodiments may utilize RF sensing with frequencies outside this range. For example, in some embodiments, 5G NR frequency bands (e.g., 28 GHz) may be used. Because RF sensing may be performed in the same bands as communication, hardware may be utilized for both communication and RF sensing. For example, one or more of the components of an RF sensing system as described herein may be included in a wireless modem (e.g., Wi-Fi or NR modem), a UE (e.g., an extended device), or the like. Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the RF sensing system may be capable of sending RF signals for communication (e.g., using 802.11 or NR wireless technology), embodiments may leverage channel estimation and/or other communication-related functions for providing RF sensing functionality as described herein. Accordingly, the pulses may be the same as those used in at least some aspects of wireless communication.

As used herein, the term PSTA may refer to a "user device," "mobile device," and/or "User Equipment" (UE) and is not intended to be specific or otherwise limited to any particular Radio Access Technology (RAT) unless otherwise noted. In general, a user device, a mobile device, and/or UE may be any wireless communication device (e.g., a mobile phone, router, tablet computer, laptop computer, tracking device, wearable (e.g., smartwatch, glasses, Augmented Reality (AR) / Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. According to some embodiments, a user device, a mobile device, and/or UE may be used to communicate over a wireless communications network. A UE may be mobile or may (e.g., at certain times) be stationary and may communicate with a Radio Access Network (RAN). As used herein, the term UE may be referred to interchangeably as an Access Terminal (AT), a client device, a wireless device, a subscriber device, a subscriber terminal, a subscriber station, a user terminal (UT), a mobile device, a mobile terminal, a mobile station, or variations thereof. Generally, UEs can communicate with a core network via a RAN, and through the core network, the UEs can be connected with external networks (such as the Internet) and with other UEs. Other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 standard, etc.), and so on.

Various aspects relate generally to the field of RF-based ranging in a wireless network and, more specifically, to a method of trigger-based passive ranging based on the selection of responding station (RSTA) – initiating station (ISTA) pairs. In some embodiments, when a passive station (PSTA) performs trigger-based passive sensing, pairs of RSTAs and ISTAs may be determined or selected from a plurality of RSTAs and ISTAs based on one or more measurements of radio frequency (RF) signals received from these stations. A location estimate of the PSTA may be determined based on listening to the ranging exchanges between the selected pairs of RSTAs and ISTAs.

Passive ranging involves a series of ranging exchanges between one or more RSTAs (e.g., Access points (AP) with known positions) and a set of ISTAs. These exchanges and the associated measurement reporting are configured such that any station may listen to the communications and utilize the ranging data to estimate its differential distance to pairs of RSTAs and ISTAs. The listening station, referred to as a PSTA, operates in a passive mode, merely receiving and processing signals without actively transmitting. By measuring the Differential Time of Arrival (DToA) of signals transmitted between the RSTAs and ISTAs, the PSTA can accurately determine its location.

The introduction of PSTAs allows for efficient and low-power location estimation, as these devices can leverage the ongoing communication exchanges between RSTAs and ISTAs. This method may significantly reduce the power consumption and complexity associated with active participation in the ranging process, making it beneficial for applications involving battery-powered devices and dense indoor environments. Further, multiple devices can listen to the same exchange to perform self-location. This helps efficient location estimation by large number of devices thus making it scalable and reducing the impact on network throughput. The Passive Location Ranging mode thus represents an advancement in the field of wireless positioning, enabling precise and efficient location services using passive listening techniques.

As noted above, passive ranging is intended to enable scalable, low-power positioning for PSTA devices. Thus, it is not desirable for the PSTA to use DToA measurements from all available RSTA and ISTA pairs. To estimate its relative location in a three-dimensional space, the PSTA needs to listen to signals transmitted by at least one RSTA and three ISTAs. However, if the RSTAs and ISTAs are randomly selected for measurement, simulations have shown that the convergence time required for location computation increases substantially. Therefore, it is beneficial to carefully determine which RSTA(s) and ISTAs to listen to for efficient location estimation.

Particular aspects of the subject matter described in this disclosure can be implemented to realize one or more of the following potential advantages. In some examples, specific RSTA-ISTA pairs may be selected according to predetermined metrics of one or more RF signals received from a plurality of RSTAs and ISTAs. This targeted listening strategy reduces power consumption during the listening and processing phases, achieves faster convergence times, and results in better positioning accuracy. Therefore, the technical solutions disclosed herein ensure efficient use of power and device resources, making them beneficial for applications in dense indoor environments where power efficiency and accurate location estimation are paramount.

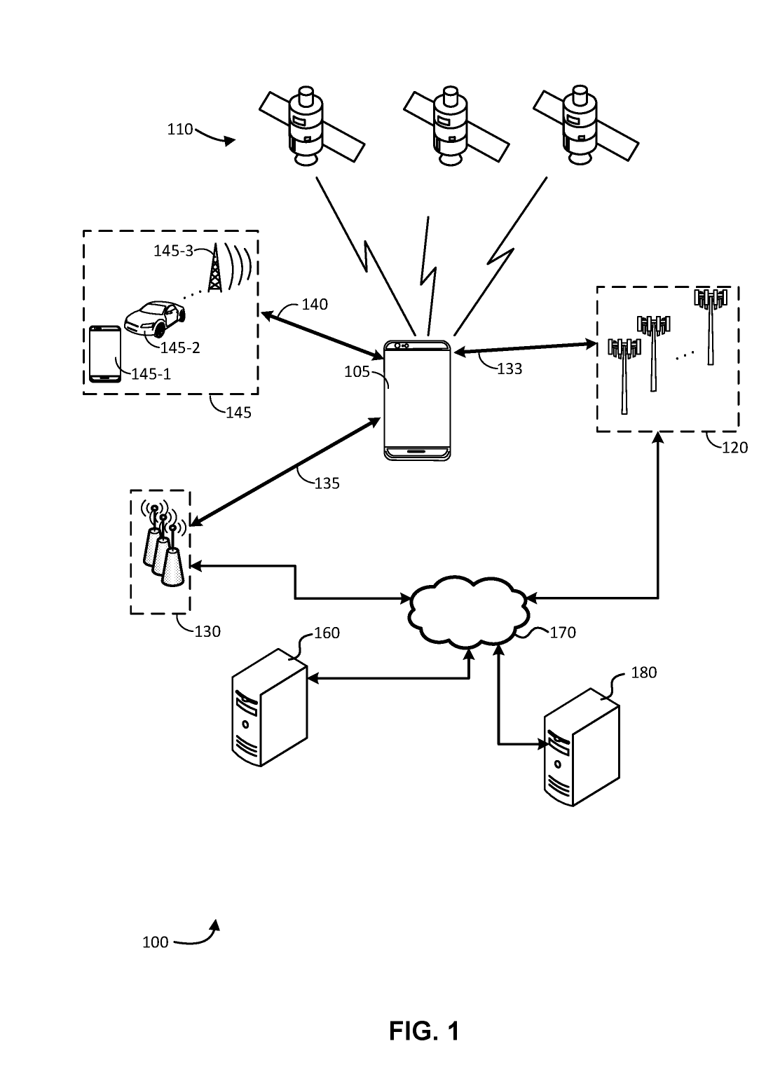

FIG. 1 is a simplified illustration of a wireless system capable of communication, positioning, and ranging, referred to herein as a “communication/positioning/ranging system” 100 in which a mobile device 105, network function server 160, and/or other components of the communication/positioning/ranging system 100 can use the techniques provided herein for passive trigger-based ranging, according to an embodiment. (That said, embodiments are not necessarily limited to such a system.) The techniques described herein may be implemented by one or more components of the communication/positioning/ranging system 100. The communication/positioning/ranging system 100 can include: a mobile device 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and or Non-Terrestrial Network (NTN) satellites; base stations 120; access points (APs) 130; network function server 160; network 170; and external client 180. Generally put, the communication/positioning/ranging system 100 may be capable of enabling communication between the mobile device 105 and other devices, positioning of the mobile device 105 and/or other devices, performing RF sensing by the mobile device 105 and/or other devices, or a combination thereof. For example, the communication/positioning/ranging system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the communication/positioning/ranging system 100. Similarly, the communication/positioning/ranging system 100 may include a larger or smaller number of base stations 120 and/or APs 130 than illustrated in FIG. 1. The illustrated connections that connect the various components in the communication/positioning/ranging system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to network function server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). In and LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as network function server 160, by accessing the network 170 via a base station 120 using a first communication link 133. Additionally or alternatively, because APs 130 also may be communicatively coupled with the network 170, mobile device 105 may communicate with network-connected and Internet-connected devices, including network function server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs – e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

Satellites 110 may be utilized for positioning in communication in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

The network function server 160 may comprise one or more servers and/or other computing devices configured to provide a network-managed and/or network-assisted function, such as operating as a location server and/or sensing server. A location server, for example, may determine an estimated location of mobile device 105 and/or provide data (e.g., “assistance data”) to mobile device 105 to facilitate location measurement and/or location determination by mobile device 105. According to some embodiments, a location server may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in the location server. In some embodiments, the location server may comprise, a Discovered SLP (D-SLP) or an Emergency SLP (E-SLP). The location server may also comprise an Enhanced Serving Mobile Location Center (E-SMLC) that supports location of mobile device 105 using a control plane (CP) location solution for LTE radio access by mobile device 105. The location server may further comprise a Location Management Function (LMF) that supports location of mobile device 105 using a control plane (CP) location solution for NR or LTE radio access by mobile device 105.

Similarly, the network function server 160, may function as a sensing server. A sensing server can be used to coordinate and/or assist in the coordination of sensing of one or more objects (also referred to herein as “targets”) by one or more wireless devices in the communication/positioning/ranging system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

An estimated location of mobile device 105 can be used in a variety of applications – e.g., to assist direction finding or navigation for a user of mobile device 105 or to assist another user (e.g., associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g., latitude, longitude and optionally altitude), relative (e.g., relative to some known absolute location) or local (e.g., X, Y and optionally Z coordinates according to a coordinate system defined relative to a local area such a factory, warehouse, college campus, shopping mall, sports stadium or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g., a circle or ellipse) within which mobile device 105 is expected to be located with some level of confidence (e.g., 95% confidence).

The external client 180 may be a web server or remote application that may have some association with mobile device 105 (e.g., may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

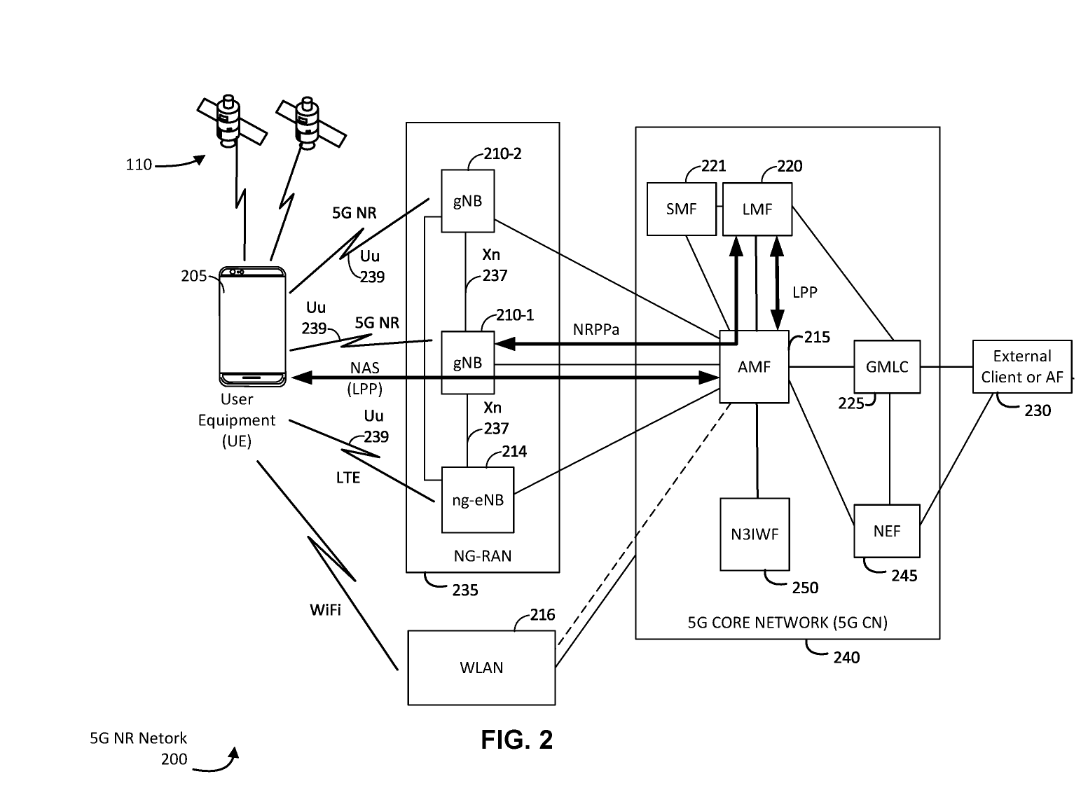

As previously noted, the example communication/positioning/ranging system 100 can be implemented using a wireless communication network, such as an LTE-based or 5G NR-based network, or a future 6G network. FIG. 2 shows a diagram of a 5G NR network 200, illustrating an embodiment of a wireless system (e.g., communication/positioning/ranging system 100) implemented in 5G NR. The 5G NR network 200 may be configured to enable wireless communication, determine the location of a UE 205 (which may correspond to the mobile device 105 of FIG. 1), perform passive trigger-based ranging disclosed herein, or a combination thereof, by using access nodes, which may include NR NodeB (gNB) 210-1 and 210-2 (collectively and generically referred to herein as gNBs 210), ng-eNB 214, and/or WLAN 216. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR network 200 additionally may be configured to determine the location of a UE 205 by using an LMF 220 (which may correspond with location server 160) to implement the one or more positioning methods. The SMF 221 may coordinate RF sensing by the 5G NR network 200. Here, the 5G NR network 200 comprises a UE 205, and components of a 5G NR network comprising a Next Generation (NG) Radio Access Network (RAN) (NG-RAN) 235 and a 5G Core Network (5G CN) 240. A 5G NR network 200 may also be called a 5G network and/or an NR network; NG-RAN 235 may be referred to as a 5G RAN or as an NR RAN; and 5G CN 240 may be referred to as an NG Core network. Additional components of the 5G NR network 200 are described below. The 5G NR network 200 may include additional or alternative components.

The 5G NR network 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR network 200. Similarly, the 5G NR network 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR network 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235–e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR network 200, such as the LMF 220 and AMF 215.

5G NR network 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR network 200), may be configured to, in response to receiving a request for location information from the LMF 220 , obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, or WLAN 216) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhanced Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205’s location) may be performed at the UE 205 (e.g., by measuring downlink PRS (DL-PRS) signals transmitted by wireless nodes such as gNBs 210, ng-eNB 214 and/or WLAN 216, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE assisted or UE based positioning of UE 205 by LMF 220.

As noted above, passive ranging involves a series of ranging exchanges between one or more RSTAs and a set of ISTAs. The PSTA may operate in a passive mode, merely receiving and processing signals without actively transmitting to estimate its differential distance to pairs of RSTAs and ISTAs. By measuring the DToA of signals transmitted between the RSTAs and ISTAs, the PSTA can accurately determine its location.

As discussed below, the RSTA may correspond to base station 120 and/or AP 130 in FIG. 1. The ISTA and PSTA may correspond to a mobile device (e.g., mobile device 105 of FIG. 1), UE (e.g., UE 205 of FIG. 2), a client device, an AP, or any device with a Wi-Fi radio.

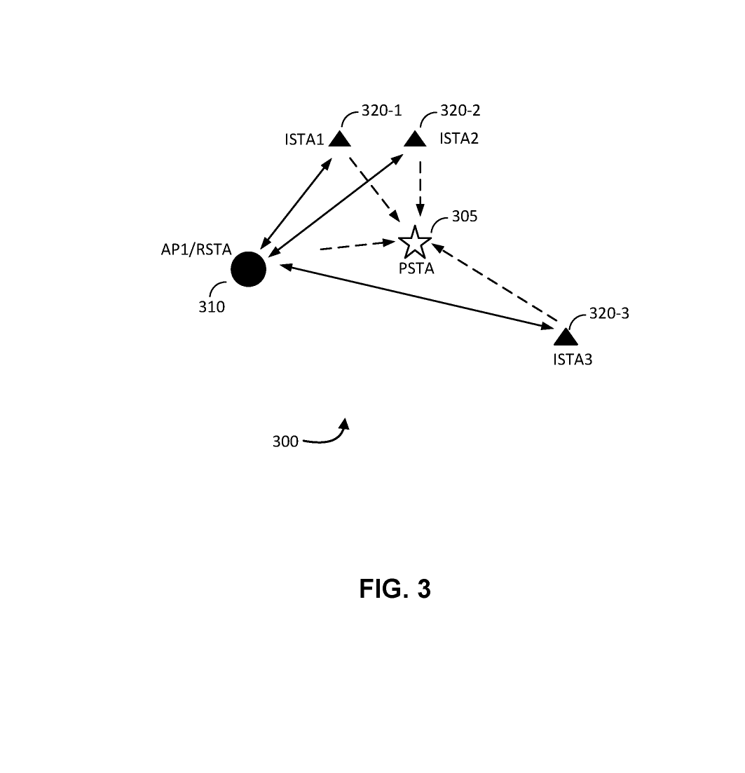

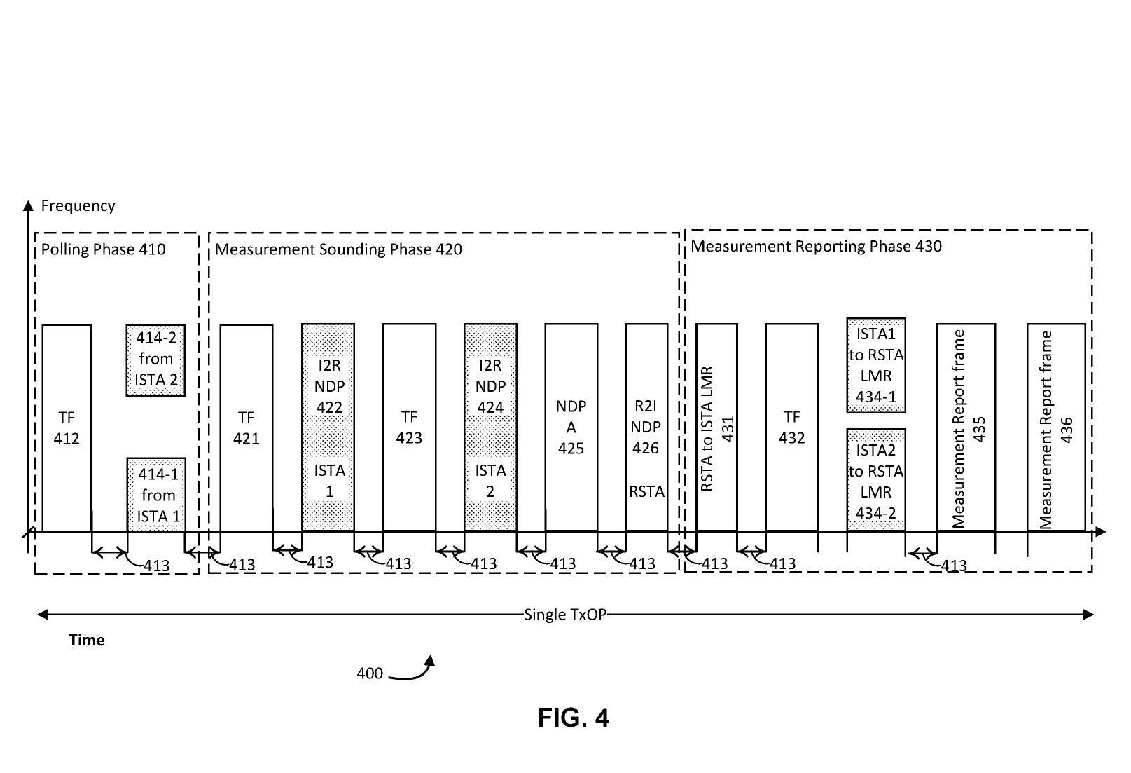

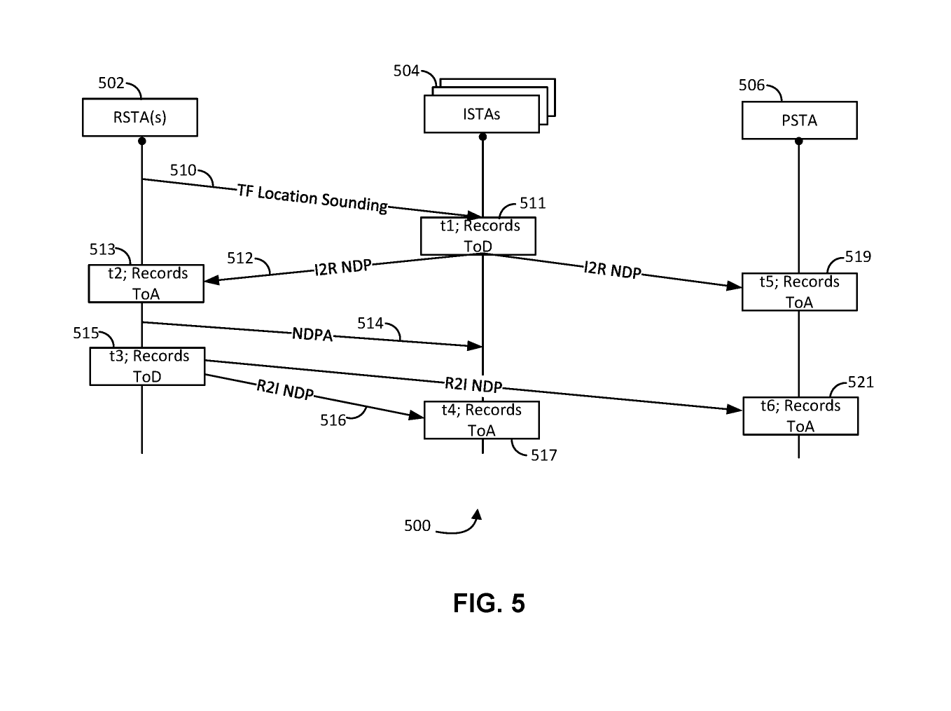

For example, FIG. 3 illustrates an example environment 300 in which passive trigger-based ranging for a PSTA may be performed, FIG. 4 is a diagram showing an example of a radio frame sequence 400 with passive trigger-based ranging between RSTA(s) and ISTAs, and FIG. 5 is a timing diagram 500 showing an example passive trigger-based ranging measurement exchange for passive ranging a PSTA. It is appreciated that FIGS. 3, 4, and 5 may be considered together for a comprehensive understanding of the passive ranging process.

As shown in FIG. 3, a PSTA 305 may determine its location estimate based on communications between an RSTA 310, and three ISTAs 320 (ISTA1, ISTA2, ISTA3). Specifically, an access point (AP) with a known location may function as the RSTA 310, which operates within a specific availability window dedicated to passive trigger-based ranging and conducts ranging exchanges with multiple ISTAs 320 (the radio frame sequence and the timing diagram will be discussed in detail below along with FIGS, 4 and 5 respectively). When performing the passive trigger-based ranging, the PSTA 305 may listen passively to the ranging exchange between the RSTA 310 and each ISTA of the ISTAs 320. The PSTA 305 may intercept transmissions from ongoing passive trigger-based ranging exchanges between the RSTA 310 and the ISTAs 320. By receiving these transmissions, the PSTA 305 may estimate its differential distance relative to each RSTA-ISTA pair and may utilize the measurements to determine precise location estimates.

As shown in FIG. 4, the radio frame sequence 400 may start with the polling phase 410 where the RSTA initiates the ranging process by sending a Trigger Frame (TF) 412 for the purpose of location polling. In TF 412, uplink resources are allocated to individual ISTAs. The ISTAs respond with Clear to Send (CTS)-to-self frames 414 to acknowledge the polling and reserve the medium for the subsequent ranging process. For example, the first CTS-to-self frame 414-1 from ISTA 1 and the CTS-to-self frame 414-2 from ISTA 2, following immediately after the TF with a Short Interframe Space (SIFS) interval 413, may be transmitted.

After the polling phase 410, following another SIFS interval, in a measurement sounding phase 420, the RSTA transmits a Passive Location Subvariant Ranging Trigger frame 421 to ISTA 1. The trigger frame 421 is addressed to individual ISTAs. The ISTA 1 responds by transmitting a High Efficiency (HE) Ranging Null Data Packet (NDP) 422 after another SIFS interval. The RSTA then repeats the process for ISTA 2 by sending another trigger frame 423 after a SIFS interval. ISTA 2 also responds by sending its HE Ranging NDP 424 after another SIFS interval. The RSTA then announces the upcoming NDP transmission by sending an NDP announcement frame 425. This ensures that all participating stations are aware of the forthcoming NDP. The RSTA then sends its HE Ranging NDP 426, completing the measurement sounding phase 420.

At measurement Reporting Phase 430, the RSTA sends Location Measurement Reports (LMRs) in frame 431 to the ISTAs. These reports contain the timing measurements and other relevant data collected during the measurement sounding phase 420. The RSTA then sends another trigger frame 432 to request LMRs from the ISTAs. ISTA 1 and ISTA 2 then send their LMRs during the frame 434 back to the RSTA. The RSTA then broadcasts a location measurement report during frame 435, summarizing the data collected from the ISTAs. In some implementations, if another RSTA takes on a secondary role, it also broadcasts its measurement report during frame 436, adding further data for enhanced location accuracy.

FIG. 5 shows the timing diagram 500 of an example passive trigger-based ranging measurement exchange for passive ranging a PSTA 506. As shown in FIG. 5, the passive trigger-based ranging for the PSTA 506 may be performed between RSTA(s) 502, ISTAs 504, and the PSTA 506 in a Passive TB Ranging measurement exchange.

Starting at arrow 510, the RSTA(s) 502 send a TF for location sounding to the ISTAs 504. At timestamp 𝑡1, in block 511, the ISTAs 504 record the Time of Departure (ToD) when they send the Initiator to Responder Null Data Packet (I2R NDP). At arrow 512, the ISTAs 504 transmit the I2R NDP to the RSTA(s) 502. At timestamp 𝑡2, in block 513, the RSTA(s) 502 record the Time of Arrival (ToA) when they receive the I2R NDP.

At arrow 514, the RSTA(s) 502 send Null Data Packet Announcement (NDPA) to inform about the upcoming NDP transmission. At arrow 516, the RSTA(s) 502 transmit the R2I NDP (Responder to Initiator Null Data Packet) to the ISTAs 504. At timestamp t3, in block 515, the RSTA(s) 502 record the ToD when they send the R2I NDP. At timestamp 𝑡4, in block 517, the ISTAs 504 record the ToA when they receive the R2I NDP.

On the PSTA 506’s side, the PSTA 506 passively listens to the exchanges between the RSTA(s) 502 and the ISTAs 504 and records the following timestamps: at timestamp 𝑡5, in block 519, the PSTA 506 records the ToA when it obtains the I2R NDP. At timestamp 𝑡6, at block 521, the PSTA 506 records the ToA when it obtains the R2I NDP.

In some implementations, the PSTA 506 may use the ISTAs 504’s and RSTA(s) 502’s timestamps, together with its own measured ToAs of the ranging NDPs ( 𝑡5 and 𝑡6), to calculate its differential time of flight to the RSTA(s) 502 and the ISTAs 504. The differential time of flight from the PSTA 506 to the RSTA(s) 502 and the ISTAs 504, DToF_PRI, can be defined according to Eqn. 1: DToF_PRI = ToF_PR - ToF_PI (Eqn. 1) where ToF_𝑃𝑅 denotes the ToF between the PSTA 506 and the RSTA(s) 502, and ToF_𝑃𝐼 denotes the time of flight between the PSTA 506 and the ISTAs 504.

The differential time of flight DToF_PRI can be calculated according to Eqn. 2: DToF_PRI = t6 – t5 – 0.5×t3’ + 0.5×t2’ – 0.5×t4’ + 0.5×t1’ (Eqn. 2) where 𝑡1’ and 𝑡4’ denote the times at which the I2R NDP was transmitted from the ISTAs 504 and the time at which the R2I NDP was received by the ISTAs 504, respectively, converted by the PSTA 506 from the ISTAs 504’s time basis to the PSTA 506’s time basis. Similarly, 𝑡2’ and 𝑡3’ denote the times at which the I2R NDP was received by the ISTAs 504 and the time at which the R2I NDP was transmitted by the RSTA(s) 502, respectively, converted by the PSTA 506 from the RSTA(s) 502’s time basis to the PSTA 506’s time basis.

At the PSTA 506, the mechanism by which 𝑡1’ and 𝑡4’ are derived from 𝑡1 and 𝑡4, the ISTAs 504 reported Carrier Frequency Offset (CFO), and the PSTA 506’s CFO measured with respect to the RSTA, is implementation dependent. Similarly, at the PSTA 506, the mechanism by which 𝑡2’ and 𝑡3’ are derived from 𝑡2 and 𝑡3, and the PSTA 506’s CFO measured with respect to the RSTA(s) 502, is also implementation dependent. Based on the DToFs between the PSTA 506 and both the RSTA(s) 502 and ISTAs, a location estimate of the PSTA 506 can be determined using hyperbolic positioning techniques.

It is appreciated that the example passive trigger-based ranging processes discussed herein are for illustrative purposes only. It will be apparent to those skilled in the art that the passive trigger-based ranging may not be limited to the example discussed herein, and substantial variations may be made in accordance with specific requirements.

As noted above, a primary objective of passive ranging is to enable low-power positioning for PSTA devices. Thus, it is not desirable for the PSTA to use DToA measurements from all available RSTA and ISTA pairs. To estimate its relative location in a three-dimensional space, the PSTA may need to listen to signals transmitted by at least one RSTA and three ISTAs. However, if the RSTAs and ISTAs are randomly selected for measurement, simulations have shown that the convergence time required for location computation increases substantially.

According to the technical solutions disclosed herein, in some examples, specific RSTA-ISTA pairs may be selected according to predetermined metrics of one or more RF signals received from a plurality of RSTAs and ISTAs. This targeted listening strategy reduces power consumption during the listening and processing phases, achieves faster convergence times, and results in better positioning accuracy. Therefore, the technical solutions disclosed herein ensure efficient use of power and device resources, making them beneficial for applications in dense indoor environments where power efficiency and accurate location estimation are paramount.

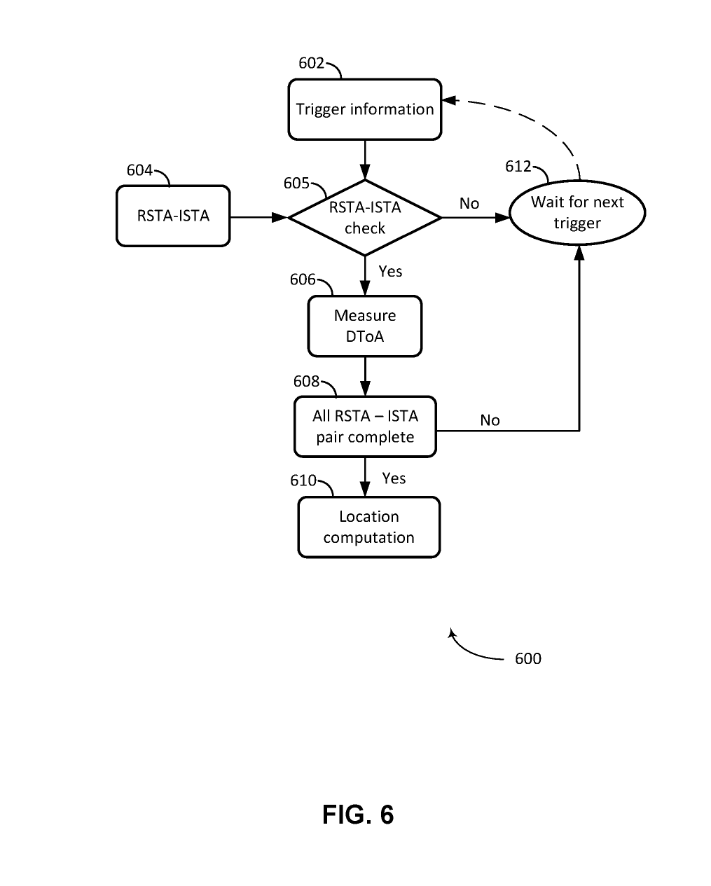

FIG. 6 is a flow chart illustrating an example of an improved passive trigger-based ranging 600 for a PSTA, according to some embodiments. Unless specifically noted otherwise, the improved passive trigger-based ranging 600 may be performed between at least one RSTA, at least three ISTAs, and the PSTA, similar to the passive trigger-based ranging discussed with respect to FIGS. 3, 4, and 5.

Starting from block 602, a trigger frame is transmitted from the RSTA(s) to the ISTAs. In some embodiments, the trigger frame may indicate the identities of the RSTA(s) and the ISTAs involved in the ranging measurement exchange.

At block 604, one or more RSTAs and more than three ISTAs may be selected according to predetermined criteria/metrics for the PSTA to listen to. As noted above, the PSTA may listen to the TF and I2R NDPs transmitted between the one or more RSTAs and the ISTAs, as discussed in FIGS. 3, 4, and 5. The PSTA may determine if the ISTA satisfies the predetermined selection criteria based on the corresponding I2R NDP. If the ISTA meets the predetermined selection criteria, the information (e.g., Recipient Address (RA)) of the ISTA indicated in the trigger frame may be saved. The PSTA may also listen to beacons transmitted from the RSTA to determine if the RSTA satisfies the predetermined selection criteria. If the RSTA meets the predetermined selection criteria, the information (e.g., Timing Advertisement (TA)) of the RSTA may be saved. The selection process and criteria will be discussed in more detail below.

At block 605, the radio frame sequence of the improved passive trigger-based ranging 600 may be checked to see if the identity of the selected RSTA(s) to the ISTAs (e.g., the corresponding TAs and/or RAs) is included. That said, whether the obtained/listened packets are transmitted between the determined one or more RSTA – ISTA pairs may be verified. For example, if the TA – RA pairs identified in TF of the radio frame sequence correspond to the list of the saved TAs and RAs (“Yes” at block 605), the PSTA may listen to the coming I2R NDPs. In some embodiments, the PSTA may also listen to the measurement reporting phase of the radio frame sequence to enhance the improved passive trigger-based ranging 600.

At block 606, the PSTA may then determine the DToAs for the selected RSTA-ISTA pairs, as discussed in FIGS. 3, 4, and 5. At block 608, the PSTA waits until the DToAs for all the selected RSTA-ISTA pairs are determined. If "Yes" at block 608, the PSTA determines the location estimate based on the DToAs, at block 610. If "No" at block 605 (e.g., not all selected RSTAs and/or ISTAs are indicated in the radio frame sequence) or block 608 (e.g., not all DToAs for the selected RSTA-ISTA pairs are ready), the improved passive trigger-based ranging 600 moves to block 612 to wait for the next trigger information.

As a non-limiting example implementation for selecting RSTA-ISTA pairs to optimize the accuracy and efficiency of passive TB ranging for location estimation, 𝑀 RSTA-ISTA pairs for a two-dimensional (2D) location estimate may be selected, where 𝑀 may be, for example, 5, and 𝑁 RSTA-ISTA pairs for a three-dimensional (3D) location estimate may be selected, where 𝑁 could be, for example, 8.

When selecting the RSTA, the selection process may begin with the RSTA broadcasting beacons indicating RSTA availability window(s). These beacons may contain information about the passive TB ranging capabilities, schedule, and bandwidth (BW) of the RSTA. The PSTA may listen to these beacons to determine the passive TB ranging capabilities, schedule, and BW of each RSTA in its vicinity. When multiple RSTAs are within range, the PSTA evaluates the Received Signal Strength Indicator (RSSI) based on the beacons. The PSTA may select the RSTA with the highest RSSI, ensuring a strong and reliable signal for the ranging process.

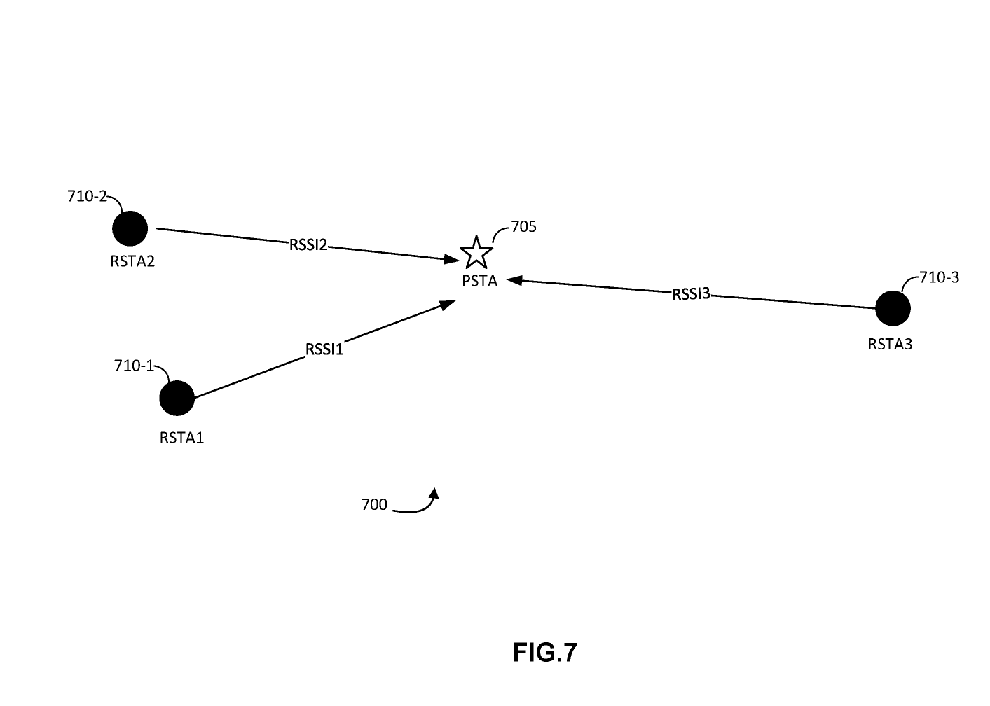

For applications requiring high accuracy, the PSTA may listen to multiple RSTAs and decide to use more than one RSTA based on predetermined criteria. In some embodiments, in scenarios where multiple RSTAs are located close to each other, the PSTA may employ the Angle of Arrival (AoA) technique to choose an RSTA that is spatially separated from others. For example, FIG. 7 is a diagram showing an example environment 700 of how RSTA may be selected for passive trigger-based ranging of PSTA 705, according to some embodiments. As shown in FIG. 7, multiple RSTAs 710 may be selected. To increase the spatial diversity of the RSTAs, RSTAs 710-1 and 710-2 (e.g., with the maximum spatial diversity among RSTAs 710-1, 710-2, and 710-3) may be selected based on AoA measurements associated with each RSTAs 710. The increased spatial diversity may help improve the accuracy of the location estimate.

When selecting ISTAs, the selection criteria may vary depending on the number of available ISTAs. For example, in cases where the number of ISTAs is limited, the PSTA may select all available ISTAs. In situations where a large number of ISTAs are present, the selection may be based on the RSSI and AoA of the I2R NDPs. For example, the PSTA may listen to all I2R NDPs to obtain AoA and RSSI measurements, ensuring a comprehensive assessment of each ISTA. The ISTAs may be selected so that they provide good RSSI and cover the PSTA from different directions, as determined by the AoA.

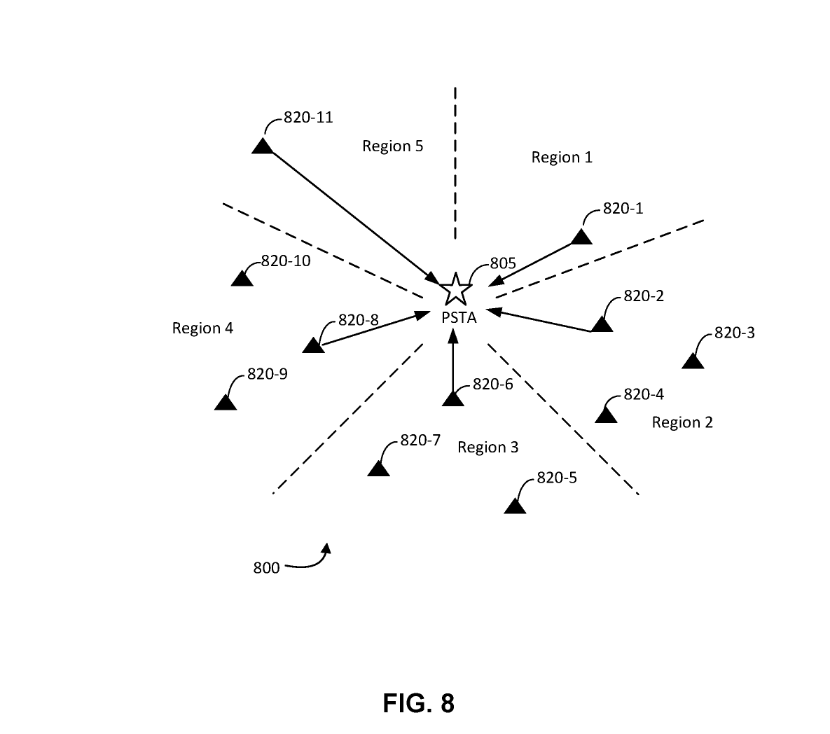

For example, FIG. 8 is a diagram showing an example environment 800 of how ISTAs may be selected for passive trigger-based ranging of a PSTA 805, according to some embodiments. As shown in FIG. 8, for performing passive trigger-based ranging for a PSTA 805, multiple ISTAs 820 may be selected. In some embodiments, the selection process may begin by dividing the environment 800 into different regions (e.g., regions 1-5) and assigning the ISTAs 820 to each of the regions based on a coarse AoA measurement of the corresponding ISTA 820.

To increase the spatial diversity of the ISTAs, a predetermined number of ISTAs from each region may be selected based on the RSSI measurement of the corresponding ISTA. For example, if one ISTA from each region is to be selected, ISTAs 820-1, 820-2, 820-6, 820-8, and 820-11 may be chosen as each of these ISTAs has the highest RSSI in the corresponding region. This multi-directional coverage enhances the accuracy of the location estimate by providing diverse signal paths for the PSTA to analyze.

Additionally or alternatively, the one or more RSTAs and more than one ISTA may be jointly selected based on calculating a rate of change of one or more predetermined measurements during hyperbolic navigation. For example, a gradient estimation during hyperbolic positioning may be performed and the RSTA – ISTA pairs with the highest gradient may be selected. This will ensure faster convergence during hyperbolic positioning.

Once the RSTA-ISTA pairs are selected, the selection may be maintained for a certain duration. During the period, the PSTA only listens to transmissions from these selected RSTA-ISTA pairs, thereby reducing overall power consumption.

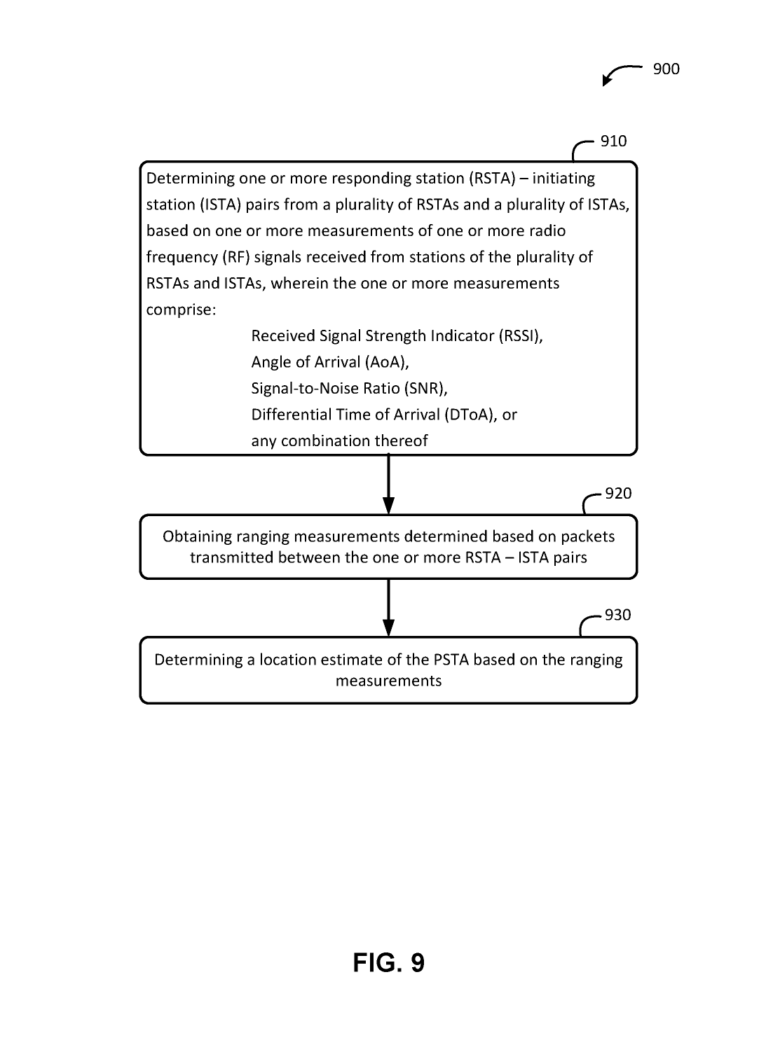

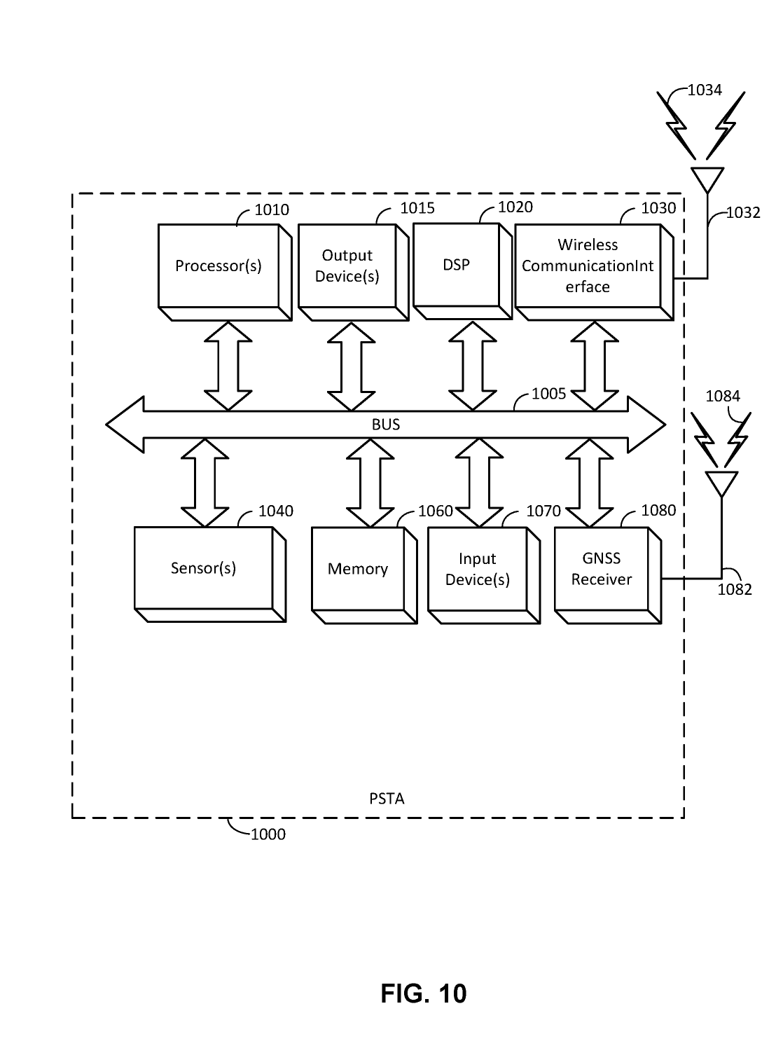

FIG. 9 is a flow diagram of method 900 of passive ranging performed by a PSTA, according to some embodiments. According to aspects of the disclosure, means for performing the functionality illustrated in one or more of the blocks shown in FIG. 9 may be performed by hardware and/or software components of a PSTA (which may comprise a mobile device (e.g., mobile device 105 of FIG. 1), UE (e.g., UE 205 of FIG. 2), the PSTA discussed in FIGS. 6, 7, and 8, or the like). Example components of a PSTA are illustrated in FIG. 10, which is described in more detail below.

Starting from block 910, one or more RSTA – ISTA pairs may be determined from a plurality of RSTAs and a plurality of ISTAs based on one or more measurements of one or more radio frequency (RF) signals received by stations of the plurality of RSTAs and ISTAs. In some embodiments, the one or more measurements may include Received RSSI, AoA, SNR, DToA, or any combination thereof.

Means for performing functionality at block 910 may also comprise bus 1005, processor(s) 1010, wireless communication interface 1030, memory 1060, GNSS receiver 1080, and/or other components of a PSTA, such as those as illustrated in FIG. 10 and described hereafter.

At block 920, ranging measurements determined based on packets transmitted between the one or more RSTA – ISTA pairs may be obtained.

Means for performing functionality at block 920 may also comprise bus 1005, processor(s) 1010, wireless communication interface 1030, memory 1060, GNSS receiver 1080, and/or other components of a PSTA, such as those as illustrated in FIG. 10 and described hereafter.

At block 930, a location estimate of the PSTA based on the ranging measurements may be determined.

Means for performing functionality at block 930 may also comprise bus 1005, processor(s) 1010, wireless communication interface 1030, memory 1060, GNSS receiver 1080, and/or other components of a PSTA, such as those as illustrated in FIG. 10 and described hereafter.

In some embodiments, determining the one or more RSTA – ISTA pairs comprises selecting more than one RSTA to increase the spatial diversity of the more than one RSTA.

In some embodiments, determining the one or more RSTA – ISTA pairs comprises obtaining a coarse AoA measurement for each ISTA of the plurality of ISTAs and selecting more than one ISTA to increase spatial diversity of the more than one ISTA based on the coarse AoA measurements.

In some embodiments, selecting more than one ISTA further comprises dividing an environment of the PSTA into different regions, associating the plurality of ISTA with the different regions based on the coarse AoA measurement of each ISTA of the plurality of ISTAs, and selecting one or more ISTAs from each region of the different regions based on an RSSI measurement of the one or more ISTAs.

In some embodiments, determining the one or more RSTA – ISTA pairs comprises jointly selecting one or more RSTAs and more than one ISTA based on calculating a rate of change of one or more predetermined measurements during hyperbolic navigation.

In some embodiments, the ranging measurements comprise DToA measurements.

In some embodiments, determining a location estimate of the PSTA based on the ranging measurements comprises confirming if the packets are transmitted between the one or more RSTA – ISTA pairs.

FIG. 10 is a block diagram of an embodiment of a PSTA 1000, which can be utilized as described herein above (e.g., in association with a mobile device 105 in FIGS. 1 and 3, UE 205 in FIG. 2, and/or the PSTA discussed in FIGS. 3-9). For example, the PSTA 1000 can perform one or more of the functions of the method shown in FIG. 9. It should be noted that FIG. 10 is meant only to provide a generalized illustration of various components, any or all of which may be utilized as appropriate. It can be noted that, in some instances, components illustrated by FIG. 10 can be localized to a single physical device and/or distributed among various networked devices, which may be disposed at different physical locations. Furthermore, as previously noted, the functionality of the PSTA discussed in the previously described embodiments may be executed by one or more of the hardware and/or software components illustrated in FIG. 10.

The PSTA 1000 is shown comprising hardware elements that can be electrically coupled via a bus 1005 (or may otherwise be in communication, as appropriate). The hardware elements may include a processor(s) 1010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1010 may comprise one or more processing units, which may be housed in a single integrated circuit (IC) or multiple ICs. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below). The PSTA 1000 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The PSTA 1000 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the PSTA 1000 to communicate with other devices as described in the embodiments above. The wireless communication interface 1030 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points. The PSTA 1000 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The PSTA 1000 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the PSTA 1000 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the PSTA 1000, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1010, DSP 1020, and/or a processor within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1010 or DSP 1020.

The PSTA 1000 may further include and/or be in communication with a memory 1060. The memory 1060 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the PSTA 1000 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the PSTA 1000 (and/or processor(s) 1010 or DSP 1020 within PSTA 1000). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware may also be used and/or particular elements may be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media may be involved in providing instructions/code to processors and/or other device(s) for execution. Additionally or alternatively, the machine-readable media may be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses.

Clause 1: A method for passive ranging performed by a passive station (PSTA), the method comprising: determining one or more responding station (RSTA) - initiating station (ISTA) pairs from a plurality of RSTAs and a plurality of ISTAs, based on one or more measurements of one or more radio frequency (RF) signals received from stations of the plurality of RSTAs and ISTAs, wherein the one or more measurements comprise: Received Signal Strength Indicator (RSSI), Angle of Arrival (AoA), Signal-to-Noise Ratio (SNR), Differential Time of Arrival (DToA), or any combination thereof; obtaining ranging measurements determined based on packets transmitted between the one or more RSTA - ISTA pairs; and determining a location estimate of the PSTA based on the ranging measurements.

Clause 2: The method of clause 1, wherein determining the one or more RSTA-ISTA pairs comprises: selecting an RSTA from the plurality of RSTAs that has the highest RSSI.

Clause 3: The method of either of clauses 1 or 2, wherein determining the one or more RSTA-ISTA pairs comprises: selecting more than one RSTA to increase spatial diversity of the more than one RSTAs.

Clause 4: The method of any one of clauses 1-3, wherein determining the one or more RSTA-ISTA pairs comprises: obtaining a coarse AoA measurement for each ISTA of the plurality of ISTAs; and selecting more than one ISTA to increase spatial diversity of the more than one ISTA based on the coarse AoA measurements.

Clause 5: The method of clause 4, wherein selecting more than one ISTA further comprises: dividing an environment of the PSTA into different regions; associating the plurality of ISTA with the different regions based on the coarse AoA measurement of each ISTA of the plurality of ISTAs; and selecting one or more ISTAs from each region of the different regions based on a RSSI measurement of the one or more ISTAs.

Clause 6: The method of any one of clauses 1-5, wherein determining the one or more RSTA-ISTA pairs comprises: jointly selecting one or more RSTAs and more than one ISTA based on calculating a rate of change of one or more predetermined measurements during hyperbolic navigation.

Clause 7: The method of any one of clauses 1-6, wherein the ranging measurements comprise differential time of arrival (DTOA) measurements.

Clause 8: The method of clause 7, wherein determining a location estimate of the PSTA based on the ranging measurements comprises: confirming if the packets are transmitted between the one or more RSTA-ISTA pairs.

Clause 9: A passive station (PSTA) comprising: at least one transceiver; at least one memory; and at least one processor communicatively coupled with the at least one transceiver and at least one memory, the at least one processor configured to: determine one or more responding station (RSTA) - initiating station (ISTA) pairs from a plurality of RSTAs and a plurality of ISTAs, based on one or more measurements of one or more radio frequency (RF) signals received from stations of the plurality of RSTAs and ISTAs, wherein the one or more measurements comprise: Received Signal Strength Indicator (RSSI) Angle of Arrival (AoA) Signal-to-Noise Ratio (SNR) Differential Time of Arrival (DToA), or any combination thereof obtain ranging measurements determined based on packets transmitted between the one or more RSTA-ISTA pairs; and determine a location estimate of the PSTA based on the ranging measurements.

Clause 10: The PSTA of clause 9, wherein, to determine the one or more RSTA-ISTA pairs, the at least one processor is configured to: select an RSTA from the plurality of RSTAs that has the highest RSSI.

Clause 11: The PSTA of either of clauses 9 or 10, wherein, to determine the one or more RSTA-ISTA pairs, the at least one processor is configured to: select more than one RSTA to increase spatial diversity of the more than one RSTAs.

Clause 12: The PSTA of any one of clauses 9-11, wherein, to determine the one or more RSTA-ISTA pairs, the at least one processor is configured to: obtain a coarse AoA measurement for each ISTA of the plurality of ISTAs; and select more than one ISTA to increase spatial diversity of the more than one ISTA based on the coarse AoA measurements.

Clause 13: The PSTA of clause 12, wherein, to select more than one ISTA, the at least one processor is configured to: divide an environment of the PSTA into different regions; associate the plurality of ISTA with the different regions based on the coarse AoA measurement of each ISTA of the plurality of ISTAs; and select one or more ISTAs from each region of the different regions based on a RSSI measurement of the one or more ISTAs.

Clause 14: The PSTA of any one of clauses 9-13, wherein, to determine the one or more RSTA-ISTA pairs, the at least one processor is configured to: jointly select one or more RSTAs and more than one ISTA based on calculating a rate of change of one or more predetermined measurements during hyperbolic navigation.

Clause 15: The PSTA of any one of clauses 9-14, wherein, to obtain the ranging measurements, the at least one processor is configured to obtain differential time of arrival (DTOA) measurements.

Clause 16: The PSTA of clause 15, wherein, to determine a location estimate of the PSTA based on the ranging measurements, the at least one processor is configured to is configured to: confirm if the packets are transmitted between the one or more RSTA-ISTA pairs.

Clause 17: A device for passive ranging, the device comprising: means for determining one or more responding station (RSTA) - initiating station (ISTA) pairs from a plurality of RSTAs and a plurality of ISTAs, based on one or more measurements of one or more radio frequency (RF) signals received from stations of the plurality of RSTAs and ISTAs, wherein the one or more measurements comprise: Received Signal Strength Indicator (RSSI), Angle of Arrival (AoA), Signal-to-Noise Ratio (SNR), Differential Time of Arrival (DToA), or any combination thereof; means for obtaining ranging measurements determined based on packets transmitted between the one or more RSTA - ISTA pairs; and means for determining a location estimate of a passive station (PSTA) based on the ranging measurements.

Clause 18: The device of clause 17, wherein the means for determining the one or more RSTA-ISTA pairs comprises: means for selecting an RSTA from the plurality of RSTAs that has the highest RSSI.

Clause 19: The device of either of clauses 17 or 18, wherein the means for determining the one or more RSTA-ISTA pairs comprises: means for selecting more than one RSTA to increase spatial diversity of the more than one RSTAs.

Clause 20: The device of any one of clauses 17-19, wherein the means for determining the one or more RSTA-ISTA pairs comprises: means for obtaining a coarse AoA measurement for each ISTA of the plurality of ISTAs; and means for selecting more than one ISTA to increase spatial diversity of the more than one ISTA based on the coarse AoA measurements.

Clause 21: An apparatus having means for performing the method of any one of clauses 1-8.

Clause 22: A non-transitory computer-readable medium storing instructions, the instructions comprising code for performing the method of any one of clauses 1-8.

What is claimed is:

1. A method for passive ranging performed by a passive station (PSTA), the method comprising:
determining one or more responding station (RSTA) - initiating station (ISTA) pairs from a plurality of RSTAs and a plurality of ISTAs, based on one or more measurements of one or more radio frequency (RF) signals received from stations of the plurality of RSTAs and ISTAs, wherein the one or more measurements comprise:
Received Signal Strength Indicator (RSSI),
Angle of Arrival (AoA),
Signal-to-Noise Ratio (SNR),
Differential Time of Arrival (DToA), or
any combination thereof;
obtaining ranging measurements determined based on packets transmitted between the one or more RSTA – ISTA pairs; and
determining a location estimate of the PSTA based on the ranging measurements.

2. The method of claim 1, wherein determining the one or more RSTA-ISTA pairs comprises:
selecting an RSTA from the plurality of RSTAs that has the highest RSSI.

3. The method of claim 1, wherein determining the one or more RSTA-ISTA pairs comprises:
selecting more than one RSTA to increase spatial diversity of the more than one RSTAs.

4. The method of claim 1, wherein determining the one or more RSTA-ISTA pairs comprises:
obtaining a coarse AoA measurement for each ISTA of the plurality of ISTAs; and selecting more than one ISTA to increase spatial diversity of the more than one ISTA based on the coarse AoA measurements.

5. The method of claim 4, wherein selecting more than one ISTA further comprises:
dividing an environment of the PSTA into different regions;
associating the plurality of ISTA with the different regions based on the coarse AoA measurement of each ISTA of the plurality of ISTAs; and selecting one or more ISTAs from each region of the different regions based on a RSSI measurement of the one or more ISTAs.

6. The method of claim 1, wherein determining the one or more RSTA-ISTA pairs comprises:
jointly selecting one or more RSTAs and more than one ISTA based on calculating a rate of change of one or more predetermined measurements during hyperbolic navigation.

7. The method of claim 1, wherein the ranging measurements comprise differential time of arrival (DTOA) measurements.

8. The method of claim 7, wherein determining a location estimate of the PSTA based on the ranging measurements comprises:
confirming if the packets are transmitted between the one or more RSTA-ISTA pairs.

9. A passive station (PSTA) comprising:
at least one transceiver; at least one memory; and
at least one processor communicatively coupled with the at least one transceiver and at least one memory, the at least one processor configured to:
determine one or more responding station (RSTA) – initiating station (ISTA) pairs from a plurality of RSTAs and a plurality of ISTAs, based on one or more measurements of one or more radio frequency (RF) signals received from stations of the plurality of RSTAs and ISTAs, wherein the one or more measurements comprise:
Received Signal Strength Indicator (RSSI)
Angle of Arrival (AoA)
Signal-to-Noise Ratio (SNR)
Differential Time of Arrival (DToA), or
any combination thereof;
obtain ranging measurements determined based on packets transmitted between the one or more RSTA-ISTA pairs; and determine a location estimate of the PSTA based on the ranging measurements.

10. The PSTA of claim 9, wherein, to determine the one or more RSTA-ISTA pairs, the at least one processor is configured to:
select an RSTA from the plurality of RSTAs that has the highest RSSI.

11. The PSTA of claim 9, wherein, to determine the one or more RSTA-ISTA pairs, the at least one processor is configured to:
select more than one RSTA to increase spatial diversity of the more than one RSTAs.

12. The PSTA of claim 9, wherein, to determine the one or more RSTA-ISTA pairs, the at least one processor is configured to:
obtain a coarse AoA measurement for each ISTA of the plurality of ISTAs; and select more than one ISTA to increase spatial diversity of the more than one ISTA based on the coarse AoA measurements.

13. The PSTA of claim 12, wherein, to select more than one ISTA, the at least one processor is configured to:
divide an environment of the PSTA into different regions; associate the plurality of ISTA with the different regions based on the coarse AoA measurement of each ISTA of the plurality of ISTAs; and select one or more ISTAs from each region of the different regions based on a RSSI measurement of the one or more ISTAs.

14. The PSTA of claim 9, wherein, to determine the one or more RSTA-ISTA pairs, the at least one processor is configured to:
jointly select one or more RSTAs and more than one ISTA based on calculating a rate of change of one or more predetermined measurements during hyperbolic navigation.

15. The PSTA of claim 9, wherein, to obtain the ranging measurements, the at least one processor is configured to obtain differential time of arrival (DTOA) measurements.

16. The PSTA of claim 15, wherein, to determine a location estimate of the PSTA based on the ranging measurements, the at least one processor is configured to is configured to:
confirm if the packets are transmitted between the one or more RSTA-ISTA pairs.

17. A device for passive ranging, the device comprising:
means for determining one or more responding station (RSTA) - initiating station (ISTA) pairs from a plurality of RSTAs and a plurality of ISTAs, based on one or more measurements of one or more radio frequency (RF) signals received from stations of the plurality of RSTAs and ISTAs, wherein the one or more measurements comprise:
Received Signal Strength Indicator (RSSI),
Angle of Arrival (AoA),
Signal-to-Noise Ratio (SNR),
Differential Time of Arrival (DToA), or
any combination thereof;
means for obtaining ranging measurements determined based on packets transmitted between the one or more RSTA – ISTA pairs; and
means for determining a location estimate of a passive station (PSTA) based on the ranging measurements.

18. The device of claim 17, wherein the means for determining the one or more RSTA-ISTA pairs comprises:
means for selecting an RSTA from the plurality of RSTAs that has the highest RSSI.

19. The device of claim 17, wherein the means for determining the one or more RSTA-ISTA pairs comprises:
means for selecting more than one RSTA to increase spatial diversity of the more than one RSTAs.

20. The device of claim 17, wherein the means for determining the one or more RSTA-ISTA pairs comprises:
means for obtaining a coarse AoA measurement for each ISTA of the plurality of ISTAs; and means for selecting more than one ISTA to increase spatial diversity of the more than one ISTA based on the coarse AoA measurements.
